(19) United States
(12) Patent Application Publication
(10) Pub. No.: US 2025/0286161 A1
(43) Pub. Date: Sep. 11, 2025

(54) METHODS OF UPCYCLING SPENT GRAPHITE FROM USED LITHIUM-ION BATTERIES

(71) Applicant: Alliance for Sustainable Energy, LLC, Golden, CO (US)

(72) Inventors: Kaitlin Elizabeth FINK, Lakewood, CO (US); Maxwell Connor SCHULZE, Arvada, CO (US); Nicholas Edward MCKALIP, Denver, CO (US); Ankit VERMA, Lakewood, CO (US); Andrew Michael COLCLASURE, Morrison, CO (US)

(21) Appl. No.: 19/072,096

(22) Filed: Mar. 6, 2025

Related U.S. Application Data
(60) Provisional application No. 63/561,827, filed on Mar. 6, 2024.

(51) Int. Cl. H01M 10/54; C01B 32/205; H01M 4/587; H01M 10/0525

(52) U.S. Cl. CPC H01M 10/54; C01B 32/205; H01M 4/587; H01M 10/0525

(57) ABSTRACT

Recognizing the significance of the solid-electrolyte-interface (SEI) formed on the surface of a graphite anode during battery operation, the methods described herein may selectively remove SEI components using specifically-selected solvents. Water, methanol, ethanol, and/or isopropanol may be used as solvents to remove specific SEI components such as lithium fluorophosphates and carbonate derived organics. These methods may recover the electrochemical performance of the recycled EOL graphite to near that of pristine graphite. By harnessing the beneficial aspects of SEI, this present disclosure may pave the way for advancing lithium-ion battery recycling.

### CROSS-REFERENCE TO RELATED APPLICATIONS

This application claims priority to U.S. Provisional Patent Application No. 63/561,827 filed on Mar. 6, 2024, the contents of which are incorporated herein by reference in their entirety.

### CONTRACTUAL ORIGIN

This invention was made with government support under Contract No. DE-AC36-08GO28308 awarded by the Department of Energy. The government has certain rights in this invention.

### BACKGROUND

Within the past several decades, lithium-ion batteries (LIBs) have emerged as the predominant solution for energy storage requirements across a broad range of applications. Due to their inherently high energy and power density and the economic benefits associated with market maturity, LIBs have become the technology of choice to support storage needs at multiple length scales, from small personal consumer electronics to electric vehicles to electric grid installations. While the use of “clean” battery storage technologies such as LIBs is critical to support the transition to an electrified and renewable-energy-powered society, the present ubiquity and continuously increasing demand for LIBs is anticipated to substantially strain the supply chain for constituent critical materials and result in substantial challenges related to disposal as these batteries reach their functional end-of-life.

Despite comprising between about 12-21% by mass of a battery cell and accounting for around 10-15% of the total battery cost, graphite (Gr)—the predominantly utilized anode material in LIBs owing to its high structural and electrochemical stability, low operating voltage vs Li, and beneficial surface passivation behavior with standard battery electrolytes—has largely been overlooked in the context of battery recycling. Graphite has long been considered a “low-value product” due to the low material cost and earth abundance of the natural form, and as such, there has been a lower motivation to pursue Gr recovery from spent LIBs. Thus, there remains a need for a responsible way to reuse, repurpose, and/or recycle the graphite in spent LIBs.

### SUMMARY

An aspect of the present disclosure is a method including placing an anode black mass into a solvent to form a mixture, agitating the mixture, separating the mixture into a used solvent and a retained solid, and drying the retained solid. In some embodiments, the method also includes inserting the retained solid into a lithium-ion battery (LIB) as an anode. In some embodiments, the solvent includes a protic solvent. In some embodiments, the protic solvent includes at least one of water, methanol, ethanol, or isopropanol. In some embodiments, the placing results in the anode black mass being at least partially submerged in the solvent. In some embodiments, the agitating includes at least one of sonicating or stirring. In some embodiments, the separating includes centrifuging the mixture and decanting the used solvent from the mixture. In some embodiments, the retained solid includes graphite. In some embodiments, the inserting includes grinding the retained solids and re-coated onto a foil. In some embodiments, the foil includes a copper foil. In some embodiments, the anode black mass has a solid-electrolyte interface (SEI) having a first thickness, the retained solid has a SEI having a second thickness, and the second thickness is less than the first thickness. In some embodiments, the LIB has a reduced capacity loss compared to an LIB with a pristine anode. In some embodiments, the method also includes repeating the agitating, the separating, and the drying, wherein the repeating is performed prior to the inserting. In some embodiments, the repeating is performed at least twice. In some embodiments, the solvent has a volume, the anode black mass has a mass, and the volume is approximately three times the mass.

An aspect of the present disclosure, a device including a lithium-ion battery comprising an anode, wherein the anode comprises a graphite that had been used as a first anode in a first lithium-ion battery, and the graphite comprises a solid-electrolyte-interface comprised at least more than half of an organic species. In some embodiments, the graphite comprises the first anode treated with a solvent. In some embodiments, the solvent comprises a protic solvent. In some embodiments, the protic solvent comprises at least one of water, methanol, ethanol, or isopropanol. In some embodiments, the first anode comprises an organic species and an inorganic species, and the solvent removed the inorganic species, resulting in the graphite. In some embodiments, the lithium-ion battery has a voltage gap of less than 300 mV at 1C.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates a method of upcycling end of life (EOL) graphite (Gr) from spent/used lithium-ion batteries, according to some aspects of the present disclosure.

FIG. 2 illustrates x-ray photoelectron spectroscopy (XPS) of the pristine Gr, EOL Gr, and EOL Gr treated with a solvent according to some aspects of the present disclosure.

FIG. 3 illustrates electrochemical performance of pristine Gr electrodes, EOL Gr electrodes, and EOL Gr electrodes treated with water, methanol, ethanol, and isopropanol for a) half-cell voltage profiles, b) symmetric cell electrochemical impedance spectroscopy (EIS), c) Q vs. rate (symmetric cells), and d) ΔV vs. rate (symmetric cells), according to some aspects of the present disclosure.

FIG. 4 illustrates losses during C/10 formation cycles with each solvent wash, according to some aspects of the present disclosure.

FIGS. 5A-B illustrate plots of solvent properties versus electrochemical performance metrics of the solvent-treated EOL Gr electrodes, according to some aspects of the present disclosure.

FIG. 6 illustrates the thermogravimetric analysis (TGA) results for different solvents, according to some aspects of the present disclosure.

FIG. 7 illustrates a comparison of symmetric cell rate performance from c/20 to 2C for pristine Gr electrodes, EOL Gr electrodes, and solvent-treated EOL Gr electrodes, according to some aspects of the present disclosure.

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

Among other things, the present disclosure relates to the use of tailored solvent washes of end-of-life graphite (Gr) anodes to selectively remove solid-electrolyte-interface (SEI) components with the goal of retaining only their beneficial passivating properties, thereby increasing the value in recycling graphite active material. The methods described herein may increase the value of recovered Gr active material relative to pristine Gr. In some embodiments, polar protic solvents may be used to selectively remove SEI components, with selectivity achieved by varying solvent properties. The physiochemical properties of the treatment solvents may correlate to the measured composition of the retained SEI and the electrochemical performance of the produced solvent treated recycled graphite anodes. The methods described herein may enable recycling processes to retain the valuable passivating benefits of SEI on graphite.

In some embodiments, the present disclosure includes “upcycling” spent graphite by using tailored chemical treatment to remove adverse (i.e., highly resistive and/or poorly passivating) species present in the SEI at end of life (EOL) while retaining beneficially passivating components of the SEI. This could facilitate reduced lithiation requirements at the cathode—since less lithium would be lost to initial surface passivation—and could also reduce or eliminate the cell formation process, which is time-intensive and costly. EOL refers to a condition when a battery's capacity falls to less than approximately 80% of its originally rated value.

Recycling processes for end-of-life lithium-ion batteries (LIBs) typically overlook the Gr active material used in anodes as a product worth recovering. This reluctance to recycle Gr largely stems from comparing the pristine active materials used to manufacture, where the Gr is less valuable than other components such as the metal bearing cathode active materials. Given the lower economic and environmental motivation recover graphite from spent LIBs, used Gr is often considered “waste.” However, Gr active material recovered from an EOL LIB is potentially more valuable than pristine Gr due to the SEI passivating layer that is formed on its surface during operation of the battery. While excessive or poorly passivating SEI is known to negatively impact battery performance, the presence of the SEI is essential for LIBs to function for extended periods.

As shown by some embodiments herein, the Gr present in the majority of EOL batteries may, when treated using the methods described herein, offer substantially higher value than the natural Gr to which it has traditionally been compared. Battery-grade Gr typically consists of natural Gr that has been highly purified and chemically and morphologically tuned to offer enhanced electrochemical performance characteristics, such as high-rate performance. During the active lifespan of the battery, degradation at the anode is predominantly believed to result from changes to the anode surface chemistry, and in particular, the growth of the passivating and often highly resistive SEI layer. While repeated lithium (de) intercalation during charge/discharge cycling may induce some degree of structural change (e.g., exfoliation, increased number of edge sites, reduced crystallite size, fracture) and may increase the number of surface defects on the Gr particles, the bulk structure of Gr is substantially retained throughout the process of standard electrochemical cycling. Thus, as described in this present disclosure, it is in fact feasible to design recycling process to recover battery-grade Gr—the “waste” of the traditional LIB recycling material stream—for reuse as battery-grade Gr.

In some embodiments, selective partial removal of SEI can be achieved through the tailored application of various classes of solvents, which may be tailored to the disparate physicochemical properties between the various chemical species that comprise the SEI.

Note the methods described herein are intended to be performed on anodes but could be performed on cathodes. References herein to “electrodes” may be read as referring primarily to anodes.

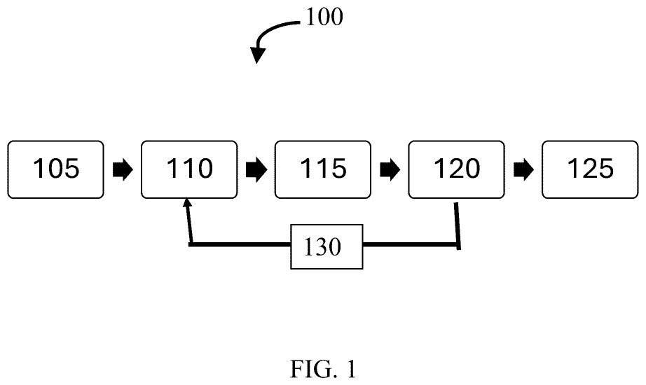

FIG. 1 illustrates a method 100 of upcycling EOL Gr from spent/used LIBs, according to some aspects of the present disclosure. In some embodiments, the method 100 first includes placing 105 an anode black mass into a solvent to form a mixture. In some embodiments, the anode black mass may have been ground or crushed prior to being placed 105. In some embodiments, the solvent contains at least water, methanol, ethanol, isopropanol, hexane, acetone, ethyl methyl carbonate (EMC), formic acid, acetic acid, methyl acetate, and/or ethyl acetate. In some embodiments, there is approximately 1 g anode black mass to approximately 10 mL of solvent. In some embodiments, the placing 105 may be described as treating the black anode mass with a solvent.

In some embodiments, the method 100 next includes agitating 110 the mixture. Agitating may be at least one of sonicating, stirring, blend, whisk, or other means of disturbing and/or combining the mixture. The agitating 110 may include multiple “rounds” of means of agitating. For example, the agitating 110 may include stirring for a period of time then sonicating for a period of time.

In some embodiments, the method 100 next includes separating 115 the mixture into a used solvent/liquid phase and a retained solid. In some embodiments, the separating 115 may include at least one of centrifuging, decanting, distilling, filtering, evaporation, sedimentation, and/or crystallization. In some embodiments, the used solvent/liquid may be discarded after the separating 115.

In some embodiments, the method 100 next includes drying 120 the retained solid. In some embodiments, the drying 120 may include heating, such as in a furnace or on a hot plate, indirect or contact drying (heating through a hot wall), drum drying, and/or vacuum drying.

In some embodiments, the method 100 next includes inserting 125 the retained solids into a lithium-ion battery LIB as an anode. In some embodiments, the inserting 125 may include grinding the retained solids and re-coated onto a current collector foil. As described herein, the inserting 125 may result in improved or substantially equivalent anode performance compared to pristine anodes.

In some embodiments, the method 100 also includes repeating 130 the agitating 110, the separating 115, and the drying 120 multiple times prior to the inserting 125. In some embodiments, the repeating 130 may be done two, three, four, five, six, seven, eight, nine, or ten times.

In exemplary testing of the method 100 of the present disclosure, end-of-life (EOL) and pristine Gr electrodes prepared with identical Gr source, electrode composition, and thickness were received from an industrial vendor as dry electrode sheets. EOL electrodes were recovered from a cell that had previously undergone cycle-life testing at approximately 45° C. (approximately 0.3 C/1 C charge/discharge between approximately 2.7 and approximately 4.2 V) to approximately 80% nominal capacity. EOL cells were disassembled by the industrial vendor, and thus details on the disassembly conditions are unknown. Electrodes were received with the composite film still attached to both sides of the copper foil current collectors and were stored and handled in an atmosphere-controlled argon (Ar) glovebox unless otherwise noted. The EOL Gr composite (i.e., the black anode mass) was mechanically delaminated (i.e., removed) as flakes from the copper foil by wrinkling and crumpling foil by hand. The delaminated flakes underwent solvent treatment (i.e., placing 105) in batches, where approximately 1 g of the delaminated EOL Gr flakes were mixed with approximately 10 mL of the treatment solvent in an approximately 50 mL centrifuge tube. In some embodiments, during the placing 105 the anode black mass was at least partially submerged in the solvent. Each mixture was sonicated (i.e., agitated 110) for approximately 60 minutes in a bath sonicator and was subsequently stirred (i.e., agitated 110) for approximately 12 h at an approximately ambient temperature. Each mixture was then centrifuged (i.e., separated 115) to precipitate out the retained solids, and the supernatant was decanted. An additional approximately 10 mL of the treatment solvent was added, sonicated (i.e., agitated 110) for approximately 10 mins, then centrifuged (i.e., separated 115) and the supernatant decanted. This latter washing procedure was repeated 130 at least once more, resulting in a total of three washes in experiments using approximately 30 mL of treatment solvent (i.e., approximately 3× the mass of the anode black mass (approximately 1 g solids/approximately 10 mL solvent)). The wet retained solids were then placed under vacuum (i.e., dried 120) for approximately 12 h before being transferred to an atmosphere-controlled Ar glovebox for storage. To benchmark the performance of the solvent-treated electrodes, pristine Gr was tested and EOL Gr was also recovered directly and also tested. Specifically, Gr composite from both pristine electrodes and EOL electrodes was obtained via mechanical delamination in the same fashion as the EOL Gr but did not undergo the solvent treatment of the present disclosure. For the EOL Gr only, the large as-recovered composite flakes (i.e., the retained solids) were lightly ground using a mortar and pestle to facilitate subsequent re-coating/inserting 125.

In some embodiments, the inserting 125 included mixing the retained solids with additional materials to form a new anode for use in a LIB. Slurries containing each kind of Gr (pristine Gr, EOL Gr, or solvent-treated EOL Gr) were prepared by adding n-methyl-2-pyrrolidone (NMP) to the manually delaminated dry composite mixtures that comprised the Gr active material, PVDF binder, and conductive carbon. Each slurry batch was prepared with approximately 30% solids loading (approximately 400 mg composite mixture+approximately 1000 mg mass of NMP). The slurry was mixed (i.e., agitated 110) in a mixer for approximately 3 mins at approximately 3000 rpm with cylindrical yttrium-stabilized zirconia milling media. The slurry was then coated onto copper foil (approximately 18 μm UMCCF-T8G-UN-18, UMC materials; total dry coating loading (graphite+residual SEI+conductive carbon+PVDF) of approximately 2 mg/cm²) under substantially ambient air conditions using a doctor blade. Cast electrodes were immediately transferred to a vacuum oven for overnight drying 120 at approximately 80° C. Following drying 120, electrodes were stored in an atmosphere-controlled Ar glovebox. The temperatures used for drying 120 may be less than traditional anode manufacture.

Circular punches (approximately 14 mm diameter) of electrode samples were prepared and packaged under argon atmosphere. Samples were transferred without air exposure to an argon-atmosphere glovebox connected to the XPS system. XPS experiments were performed using a PHI 5000 VersaProbe II System (Physical Electronics). The spectra were obtained using Al Ka radiation (hv of approximately 1486.6 eV) (approximately 100 μm, approximately 25 W), Ar⁺ and electron beam sample neutralization in fixed analyzer transmission mode. The XPS binding energies were calibrated to the carbon black component in the C1s spectra at approximately 284.8 eV. Peak fitting was performed using Shirley background correction and a Gaussian-Lorentzian curve synthesis.

Raman spectroscopy was conducted on all graphite samples using a Horiba Xplora Plus Confocal Raman Microscope configured with an approximately 638 nm laser. Analysis was conducted from approximately 1200 cm⁻¹ to approximately 1800 cm⁻¹, with an exposure time of approximately 20 s and approximately 30 s accumulations, an approximately 10% filter, a grating of approximately 1200, and at approximately 100× magnification. The same parameters were run on a map over the surface of the sample in an approximately 400 μm×400 μm square with approximately 9 spots on each axis, resulting in approximately 81 spectra per sample. The resulting spectra were baseline corrected and smoothed using a post-processing technique developed in-house, consisting of Savitsky-Golay smoothing and a Zhang baseline correction. Smoothed peak intensities of the D band (approximately 1350 cm⁻¹) and G band (approximately 1550 cm⁻¹) were extracted, and their ratio (I_{D})/I_{G}) was calculated for each spectrum.

Thermogravimetric analysis (TGA) was performed on all graphite samples using a TA TGA Q500. The graphite samples were loaded into platinum pans with a sample mass of approximately 15 mg. The samples were then ramped from room temperature to approximately 50° C. at approximately 10° C./min and held for 30 mins, in an attempt to desorb (i.e., dry) any gaseous species from the surface of the graphite. The samples were subsequently ramped at approximately 10° C./min to approximately 800° C. The wt % for each sample was calculated with approximately 100% wt % at approximately 60° C.

Circular punches (approximately 14 mm diameter) of the anode samples (pristine Gr, EOL Gr, or EOL/washed Gr) were prepared and weighed under argon atmosphere. Initially, CR2032 coin-type half cells were assembled in an Ar glovebox. Each half cells contained an approximately 14 mm diameter anode opposite an approximately 15 mm diameter Li foil, Celgard 2325 separator (approximately ¾″ diameter), and approximately 50 μL of Gen2 electrolyte (Tomiyama Pure Chemical Industries, Ltd; EC:EMC of approximately 2.994:7 with approximately 1.121 M LiPF₆). Following assembly, half cells were transferred into a Multi-Zone Temperature Chamber (MZTC) connected to a multi-channel cycler (Arbin Instruments) and were allowed to substantially wet for approximately 5 hr at approximately 30° C. Half cells were then cycled from approximately open-circuit voltage (OCV) to approximately 0.001 V at a C/20 rate (constant-current (CC)), and subsequently underwent one full delithiation/lithiation cycle at C/20 (CC) between approximately 1.2 V and approximately 0.001 V, ending in the lithiated state; cells were subsequently held at approximately 0.001 V (constant-voltage (CV)) until the applied current decayed to less than approximately C/50. All cycling was conducted at approximately 30° C.

Half cells were disassembled in the fully lithiated state in an Ar glovebox using a decrimping instrument (MTI) and the lithiated anodes were recovered, taking care to avoid damage to the electrode edges. Each recovered electrode was then individually reassembled into a CR2032 symmetric cell, with assembly conducted one-at-a-time, rather than batch-wise, to minimize any impacts of electrolyte dry-out. In each symmetric cell, a lithiated anode was assembled opposite to an as-prepared (i.e., not lithiated) anode from the same sample batch with Celgard 2325 separator (approximately ¾″ diameter) and approximately 50 μL of Gen2 electrolyte. Following assembly, half cells were transferred into a MZTC connected to a multi-channel cycler (Arbin Instruments) and were allowed to wet for approximately 5 hr at approximately 30° C. Symmetric cells were cycled from approximately −0.5 to approximately 0.5 V and approximately 30° C. according to a sequence of protocols designed to probe various aspects of the cells' performance. Specifically, symmetric cells underwent formation cycling (10 cycles at C/10 CC/CV (charge/discharge)) followed by a C/20 CC/CV reference cycle. Cells were then brought to approximately 0 V at a C/10 rate and were held at approximately 0 V for approximately 3 hr. Potentiostatic EIS was conducted at 0 V using an integrated Gamry 5000E between approximately 100 kHz to approximately 0.01 Hz, with a perturbation of approximately 10 mV; cells were maintained at approximately 30° C. throughout EIS testing. Following EIS, cells underwent a rate performance test consisting of five CC/CC cycles at varying rates (C/10, C/5, C/2, 1C, 2C, 3C). A C/20 CC/CC reference performance cycle was conducted after each rate to evaluate capacity retention. Finally, cells underwent a simple cycle-aging sequence of approximately 62 C/10 charge/discharge cycles.

For half cells, each recast anode punch was individually weighed, and the mass of Cu foil subtracted to yield precise active mass loadings for each cell. C-rates were calculated based on the reported initial composition of the anode composite, i.e., presuming that approximately 93% of the recast electrode mass was active Gr with a nominal capacity of approximately 330 mAh/g-Gr. For symmetric cells, C-rates during the formation cycles were adjusted to reflect the actual C/20 discharge (delithiation) capacity achieved in half-cell format by the lithiated electrode. C-rates for each symmetric cell were again adjusted prior to the rate performance test segment to reflect the actual C/20 discharge capacity of the symmetric cell following formation cycling.

Correlation analysis was utilized to elucidate statistically meaningful trends between the physicochemical properties of treatment solvents, observed half-cell and symmetric-cell electrochemical metrics, and anode material parameters measured via XPS and Raman analysis. For each pair of variables, an R² value was calculated using a linear least-squares regression fit.

The anode electrodes upon which the present upcycling method 100 was utilized were sourced from an industrial vendor as electrode sheets harvested from a large-format pouch cell cycled to EOL. Pristine electrode sheets comprising the same materials and compositional ratios but having never been exposed to electrolyte or an operational cell environment were acquired from the same vendor to serve as a control sample.

The feedstock for the anode upcycling process was obtained from these electrode sheets by mechanically delaminating the composite film from the copper foil current collectors. The “anode black mass” therefore includes the Gr active material, the binder (PVDF), conductive carbon, and, for the EOL material, any formed SEI. The minimum required processing to achieve direct recycling of any such feedstock would involve formulating a slurry and re-casting of this material onto a fresh current collector, which necessitates exposure to a coating solvent. In this case, the impact would be to redistribute all components—including graphite, conductive carbon, SEI species, and binder—within the re-cast electrode. To evaluate this minimum-processing condition, both EOL and materially identical pristine graphite were suspended in a coating solvent, and recasting onto Cu foil was attempted. When n-methyl-2-pyrrolidone (NMP; the predominantly employed solvent for PVDF binder) was used as a coating solvent, the delaminated/re-cast pristine graphite feedstock was readily resuspended into a homogeneous slurry and printed smoothly onto Cu foil. However, under identical processing conditions, the EOL material gelled and produced a chunky slurry that printed to a low-quality and heterogeneous electrode.

In some embodiments, alternative solvents may also be used to solvate PVDF-including dimethylformamide (DMF) and dimethylsulfoxide (DMSO) with substantially similar results. Rinsing the EOL Gr with ethyl methyl carbonate (EMC) to wash away any LiPF₆ and EC from residual dried electrolyte did not prevent gelling of the slurry on subsequent addition of NMP. Grinding the EOL Gr with a mortar and pestle to mechanically break up agglomerates was found to prevent gelling of the subsequently formed slurry, but the slurry exhibited extremely low viscosity and still prints a low quality and heterogeneous electrode. This suggests that the “no-treatment” condition (i.e., pure resuspension/recasting of EOL Gr) is not practically viable and suggests that residual SEI on EOL Gr may be a predominant factor hindering the direct recasting of EOL Gr feedstocks. Specifically, the observed gelling behavior indicates that the SEI remaining on the EOL Gr interferes with the slurry rheology, and that that some degree of treatment prior to slurry reformulation may be required to obtain a workable electrode for subsequent analysis.

In some embodiments, polar protic solvents such as water and small primary alcohols present themselves as inexpensive, safe, and useful treatment solvents for EOL Gr recycling. Note that the addition of water to EOL Gr results in significant bubbling indicating that the feedstock still has highly reducing compounds (SEI components and/or lithiated Gr) capable of reducing active protons to hydrogen gas. This reductive reactivity may be responsible for the poor-quality slurries and electrodes upon addition of NMP, and that high-quality slurries and electrodes can be fabricated if the reactive compounds are neutralized prior to slurry formulation. Protons serve as a facile neutralizing species for such reductive reactivity, so the EOL Gr was treated with several protic solvents prior to NMP addition and reprinting. Table 1 shows selected relevant physicochemical properties of the polar protic solvents (water, methanol, ethanol, isopropanol) that were selected for initial evaluation. Polarity index and dielectric constant reflect the ability of the various solvents to selectively solvate SEI species based on their polarity, while pKₐ indicates how readily available protons are to neutralize the reductive reactivity. Being able to vary these properties by varying the solvent allows both the quantity and identity of the SEI species that are removed to be tune during the recycling process and to explore the resulting impacts on the electrochemical performance of the recycled Gr. Additionally, each of the reported solvents are inexpensive, abundant, and present low safety and health risks, which make them viable candidates for implementation in a larger-scale recycling process.

TABLE 1
Solvent Properties

| | Polarity | Dielectric | |
|---|---|---|---|
| Solvent ID | Index | Constant | Solvent pKₐ |
| Water (H₂O) | 10.2 | 78.355 | 14 |
| Methanol (MeOH) | 5.1 | 32.613 | 15.521 |
| Ethanol (EtOH) | 4.3 | 24.852 | 15.85 |
| Isopropanol (IPA) | 3.9 | 19.264 | 16.48 |

Before understanding how the solvent treatments ultimately influence the electrochemical performance of the recycled Gr electrodes, it is helpful to understand how the physical characteristics of the EOL Gr samples are affected by treatment with each solvent. Raman mapping of the solvent treated EOL Gr samples was performed, and the D-band to G-band intensity ratios (I_{D}/I_{G}) were used to assess the density of defect sites in each Gr sample. The EOL Gr exhibits significantly greater I_{D}/I_{G} than pristine Gr, indicating that the aging process in the cell has damaged the crystalline structure of the Gr. All the solvent treated EOL Gr samples exhibit marginally smaller I_{D}/I_{G} and less structural disorder than the untreated EOL Gr, though there is not a statistically significant dependence on the identity of the treatment solvent.

Thermogravimetric analysis (TGA) of the solvent-treated EOL Gr samples was performed under an inert N₂ purge gas environment, such that all mass loss events are attributable to the formation of gaseous species via decomposition and volatilization, rather than oxidation. For this analysis, an EOL Gr sample washed with ethylmethyl carbonate (EMC) was included as a control rather than pure EOL Gr due to safety concerns regarding potential evolution of hydrofluoric acid upon thermal degradation of residual LiPF₆ salt. EMC, the primary low-viscosity solvent in standard battery electrolytes, was intentionally selected to minimize disruption to the existing solid-phase SEI on the EOL Gr samples while removing residual LiPF₆ and ethylene carbonate (EC) remaining on the Gr surface following cell disassembly. Mass loss in the regime below the PVDF decomposition temperature (T less than approximately 475° C.) is highly dependent on the identity of the treatment solvent. In this lower-temperature region, mass loss is associated with the decomposition of SEI species; thus, a greater observed mass loss indicates that a greater amount of organic SEI components remains on the EOL Gr after solvent treatment. While subtle differences are observed in the profile shapes between the various solvent-treated samples (e.g., the mass loss “shoulder” present at approximately 350° C. for the MeOH- and EtOH-washed samples), such features are minor and preclude robust assignment of mass-loss events to thermal decomposition processes of specific SEI species through TGA alone. However, the overall mass loss (i.e., total y-axis signal change) below the PVDF decomposition temperature can be taken to reflect the total quantity of SEI remaining on the washed samples. Increasing mass loss of SEI is found to inversely track with solvent polarity; thus, the treatment solvents appear to remove a total quantity of SEI in the following order: IPA less than EMC less than EtOH less than MeOH less than H₂O. Interestingly, the mass loss in the IPA sample is found to be higher than that of the EMC-washed control sample—a result that was verified through repeated replicate experiments. This would appear to suggest that IPA removes a lesser mass of SEI than the (ostensibly minimally SEI-disruptive) EMC rinse solvent. This behavior could imply that IPA is leaving behind mass as an organic residue; that IPA is reacting with native SEI species to produce a higher-mass SEI product; or that the EMC is removing SEI mass in addition to residual EC and LiPF₆ solids. Overall, the TGA results indicate that the more polar and lower pKa the treatment solvent, the greater the mass of SEI is removed.

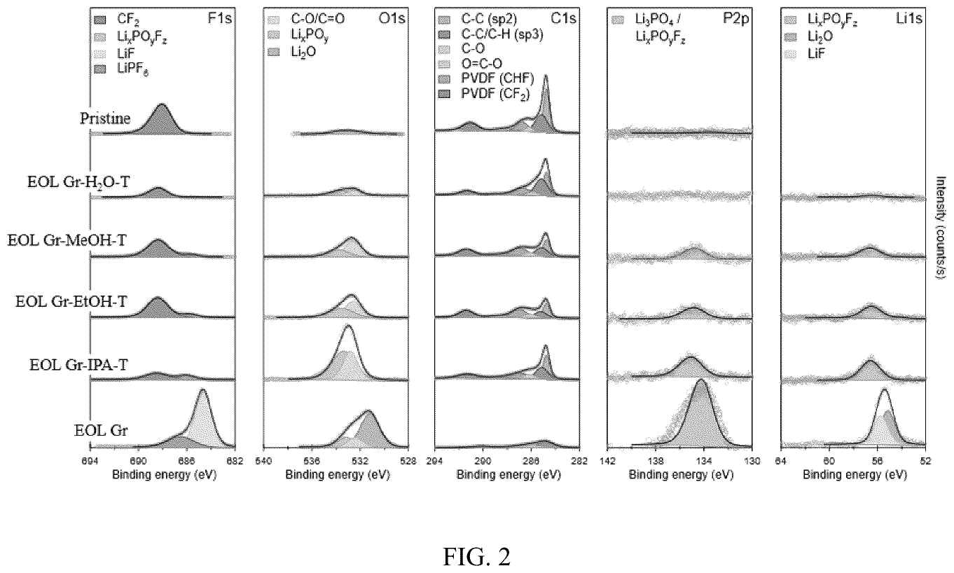

X-ray photoelectron spectroscopy (XPS) performed on the solvent treated EOL Gr samples indicated that the different solvents resulted in chemically different surfaces on the Gr. FIG. 2 shows the XPS spectra of the pristine Gr (pristine), EOL Gr, and solvent treated EOL Gr samples (solvent treated samples were treated with water (shown as EOL Gr-H₂O-T), methanol (shown as EOL Gr-MeOH-T), ethanol (shown as EOL Gr-EtOH-T), and isopropanol (shown as EOL Gr-IPA-T). The pristine Gr sample shows the expected signals, with the C1s spectrum showing mainly sp² carbon from the graphite itself with some other signals from adventitious carbon and the PVDF binder, and the F1s spectrum showing the expected signal from the PVDF binder. In comparison, those same signals are gone from the EOL Gr sample, indicating that the underlying graphite and PVDF binder are covered by a layer. The layer comprises residual LiPF₆ salt from the electrolyte and typically reported SEI species such as highly oxidized carbon species, Li₂O, LiF, and LiₓPO_{y}F_{z}. The Li1s, F1s, and Ols spectra of each of the solvent treated EOL Gr samples show that all the solvents completely remove LiF and Li₂O. The removal of the more organic and phosphate-based components of the SEI is dependent on the identity of the treatment solvent, with signals from LiₓPO_{y}F_{z}, LiₓPO_{y}, C—C═O roughly decreasing with decreasing solvent polarity (H₂O greater than MeOH greater than EtOH greater than IPA). The removal of these SEI components also corresponds with an increase in CF₂, CHF, and sp² carbon as graphite and PVDF was uncovered. These results generally indicate that all the polar protic solvents tested readily strip off all the inorganic components of the SEI (LIF, Li₂O, and potentially Li₂CO₃) while the amount of the organic and phosphate-based SEI components can be more selectively removed by choosing which solvent to use for the treatment.

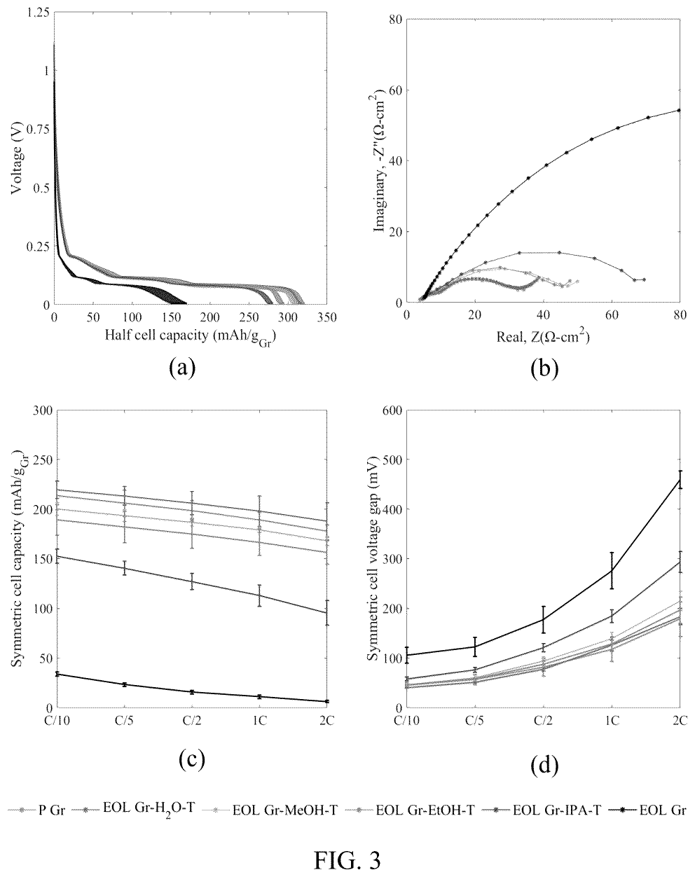

To understand how selective removal of SEI layers influence electrochemical performance in recycled Gr, the solvent treated EOL Gr samples, and a sample of pristine Gr were formulated into NMP-based slurries and printed and dried into electrodes for electrochemical performance assessment. The electrochemical performance of the as-received EOL Gr electrode (not delaminated or reprinted) was also assessed as a control. FIG. 3 shows the electrochemical performance of half cells (Li∥Gr) and symmetric cells (Gr∥Gr) containing the above-described electrodes. On assembly, the average half-cell voltages for pristine, water-washed, methanol-washed, ethanol-washed, IPA-washed and EOL Gr cells are approximately 2.89V, approximately 2.89V, approximately 2.65V, approximately 2.77V, approximately 2.72V and approximately 2.21V respectively indicating a near-full delithiation state of the graphite. It is interesting to note that the cycled samples have nearly 500 mV lower initial half-cell voltage as compared to pristine and all solvent-washed samples. Residual Li may be present in the EOL Gr samples—which were disassembled by the industrial vendor at an unknown state of charge—and that a portion of this residual Li is chemically deintercalated in the washing procedure, causing the potential of washed samples to be higher.

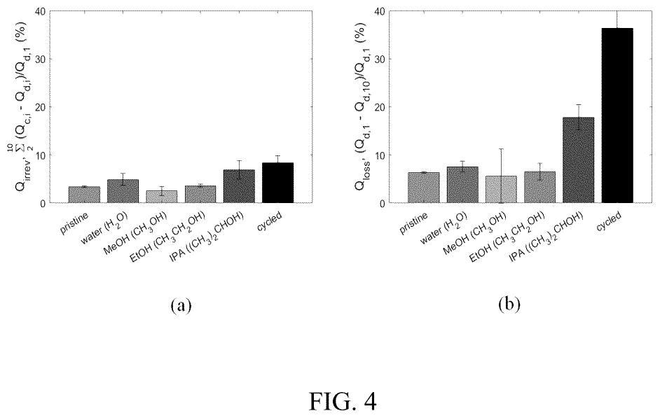

FIG. 4(b) shows the normalized capacity loss by subtracting the discharge capacity obtained in the final C/10 symmetric cell break-in cycle from the nominal discharge capacity in the first break-in cycle. Here, the discharge capacity reflects the achievable performance of the material, and its magnitude declines with cycling due to Li losses to the SEI. For all cells tested, the magnitude of Qₗₒₛₛ is substantially higher than the magnitude of Qᵢᵣᵣₑᵥ. This is like the result of end of charge/discharge slippage of Li stoichiometries in each graphite electrode that occurs with repeated cycling due to LLI (loss of lithium inventory), resulting in varying reversible capacity access in each cycle. Despite the difference in calculation methodology, however, the same trends in capacity loss are observed as in FIG. 4(a)—namely, that treating EOL Gr with MeOH, EtOH, and H₂O solvents leads to formation capacity losses equivalent to or lesser than (within sample variability) that of pristine Gr (labeled P Gr), while IPA washing leads to formation capacity losses higher than that of the other treatment solvents, but still lesser than that of the untreated EOL Gr.

The half-cells first undergo a slow C/20 cycle consisting of lithiation from initial voltage to 5 mV and a subsequent delithiation to approximately 1.2 V with an approximately 2-minute rest in between. Average coulombic efficiencies (CE) of the half cells for this 1^{st} cycle are approximately 89.19%, approximately 86.58%, approximately 87.67%, approximately 87.62%, approximately 88.20% and approximately 74.36% for pristine, water-washed, methanol-washed, ethanol-washed, IPA-washed, and unwashed EOL Gr. The 1^{st} cycle CE is generally interpreted to indicate loss of lithium to the SEI. Following this first C/20 cycle, the half cells are subsequently lithiated to approximately 5 mV at C/20. FIG. 3(a) shows the half-cell voltage profiles for all samples, with the shaded region indicating the spread of cell replicates at each condition. Specific capacities were calculated by normalizing the experimentally measured capacity value (mAh) by the nominal graphite content in each sample, presuming identical constituent ratios to the pristine material (i.e., approximately 93 wt % Gr). The average specific capacity trends downward from pristine (approximately 321 mAh/g_{Gr}), water-washed (approximately 317 mAh/g_{Gr}), methanol-washed (approximately 308 mAh/g_{Gr}), ethanol-washed (approximately 294 mAh/g_{Gr}), IPA-washed (approximately 277 mAh/g_{Gr}) and unwashed EOL (approximately 159.68 mAh/g_{Gr}) cells. Clearly, the washing step enhances the performance of EOL graphite with >100 mAh/g_{Gr} specific capacity improvement regardless of the wash solvent identity. The thick SEI present on EOL graphite can cause graphite isolation and kinetic limitations for Li insertion. Thus, the observed improvement in treated samples is most likely attributable to removal of SEI from the Gr surface (i.e., the decrease in thickness of the SEI) by the treatment solvents, which allows for reactivation of graphite host sites for lithiation. However, the limitations of using a mass-normalized metric to judge the quality of the upcycled product must not be overlooked. As indicated above, specific capacity as calculated using the nominal graphite content in each sample does not account for the weight of SEI species, which according to TGA results may contribute up to several weight percent to the overall sample mass. Thus, a normalization approach that assumes a constant Gr fraction in each sample can artificially lower the apparent specific capacity of treated graphite samples, because of the heavier SEI mass in the cycled samples. Nevertheless, the half-cell voltage profiles and attained capacities are a good indicator of the electrochemical performance of the upcycled anode material, as further indicated by subsequent analyses.

Symmetric cells, whereby two identical electrodes-one in a charged state and one in a discharged state—are paired within a coin cell format, provide a unique configuration within which to study SEI behavior. Symmetric cells enable evaluation of the SEI within a carefully controlled potential window with a fixed Li inventory while avoiding convolution that may be introduced by either a Li foil (infinite source of lithium-ions and reactive surface) or a transition-metal oxide cathode (subject to metal dissolution, oxygen evolution, and crosstalk). In the present study, symmetric cells were assembled by pairing a lithiated graphite anode recovered from half-cell tests with a (non-lithiated) graphite electrode prepared from the same preparation batch (pristine, EOL, or EOL/washed). In all cases, every effort was made to minimize variation in the as-cast mass loadings between the paired electrodes; given the nature of hand-cast electrodes, the difference in mass loading between the two symmetric electrodes (as measured in the unlithiated state) was on average approximately 0.10 mg/cm² across all conditions tested.

Formation cycling was conducted in the symmetric cell format by cycling between approximately-0.5 V and approximately 0.5 V to redistribute the fixed Li inventory and drive any SEI (re) forming reactions, with the goal bringing the two paired electrodes to a maximally similar state. Preliminary studies evaluating the state-of-charge dependence of impedance response suggested minimal response variation within the symmetric cell operating window, and thus approximately 0 V (nominally 50% state-of-charge (SOC) for each Gr electrode in the symmetric cell) was selected as a standard potential at which to conduct electrochemical impedance spectroscopy (EIS). The use of the 50% SOC condition for EIS testing also ensures that both electrodes are in the same state of lithiation, ostensibly resulting in equal contributions to impedance response from both electrodes.

FIG. 3(b) shows the impedance spectra comparison of all samples. The EOL Gr samples exhibit extremely high impedance, with real magnitudes going up to 500 Ω-cm². The impedance of both pristine and solvent treated samples is approximately an order of magnitude lower compared to EOL graphite. The pristine and water-washed samples show the lowest overall impedance, with overlapping spectra. The EIS spectra of MeOH- and EtOH-washed samples overlap as well, and they have the next-highest impedance. The IPA-washed sample shows the highest impedance of all studied treatment conditions. These results indicate that protic solvents with decreasing polarity (H₂O<MeOH<EtOH<IPA) leaves a more resistive SEI on the treated anodes.

Equivalent circuit fits have also been performed to quantify the SEI and charge transfer resistances from the impedance spectra. EIS spectra of the EOL Gr were not fit due to poor fit quality with the identified equivalent circuit model. On average, SEI resistance is found to increase with solvent treatment as MeOH less than IPA approximately equivalent to pristine less than H₂O less than EtOH, with all values lying in the range of about 2 Ω-cm² to about 4 Ω-cm². It should be noted, however, that the observed variability between replicate samples was on the same order of magnitude as the SEI resistance value, making absolute ordering of sample performance challenging. The charge transfer resistance of solvent-treated systems was found to increase as H₂O less than MeOH approximately EtOH less than IPA, with all values lying in the range of approximately 20 Ω-cm² to approximately 53 Ω-cm².

In some embodiments, a solvent of water may restore the least-resistive surface conditions to EOL Gr, with charge transfer resistance values for the water-washed EOL Gr closely matching that of the pristine sample. However, the SEI resistance for water-washed EOL Gr samples is slightly higher than that of pristine Gr, outside the range of sample variability. Methanol- and ethanol-washed EOL samples showed approximately 30% higher charge transfer resistance than the pristine sample, suggesting that a thicker SEI that is more resistive to Li⁺ diffusion remains on the surface. However, the SEI resistance for the MeOH-washed sample is the lowest of all treatments evaluated and is in fact even lower than that of the pristine sample. This may indicate that MeOH treatment (either the specific convolution of remaining SEI species, or residual MeOH remaining on the surface) facilitates the evolution of an improved SEI during formation cycling, relative to the native SEI evolved on pristine anode material. Finally, IPA treatment appears to leave an SEI that is most resistive to charge transfer, with a charge transfer resistance more than double that of pristine anodes.

Following EIS, symmetric cells underwent rate performance testing from C/10 to 2C to evaluate differential improvements to rate capability induced by the various treatment solvents. FIG. 3(c) and FIG. 3(d) show the specific capacity and voltage gap between lithiation and delithiation for all symmetric cells. On average, specific capacities trend downward as H₂O-washed>pristine>MeOH-washed>EtOH-washed>IPA-washed>unwashed EOL Gr samples at all rates. As mentioned before, performance metrics that require normalization to electrode masses have the potential to be misleading in this study due to unaccounted for SEI mass. Instead, non-normalized metrics such the voltage gap between charge and discharge of the symmetric cells at the different rates is another way to assess the impact of a selectively removed SEI on the rate capability of recycled Gr electrodes. The voltage gap trends are water approximately pristine<MeOH approximately EtOH<IPA<cycled. Small voltage gaps are indicative of good rate performance with lower kinetic and transport limitations, indicating that the highly resistive parts of the SEI have been effectively removed by the solvent treatment. By this metric, water, MeOH, and EtOH can almost restore the EOL Gr to its pristine performance and washing with isopropanol is better than removing none of the SEI in the case of the EOL Gr.

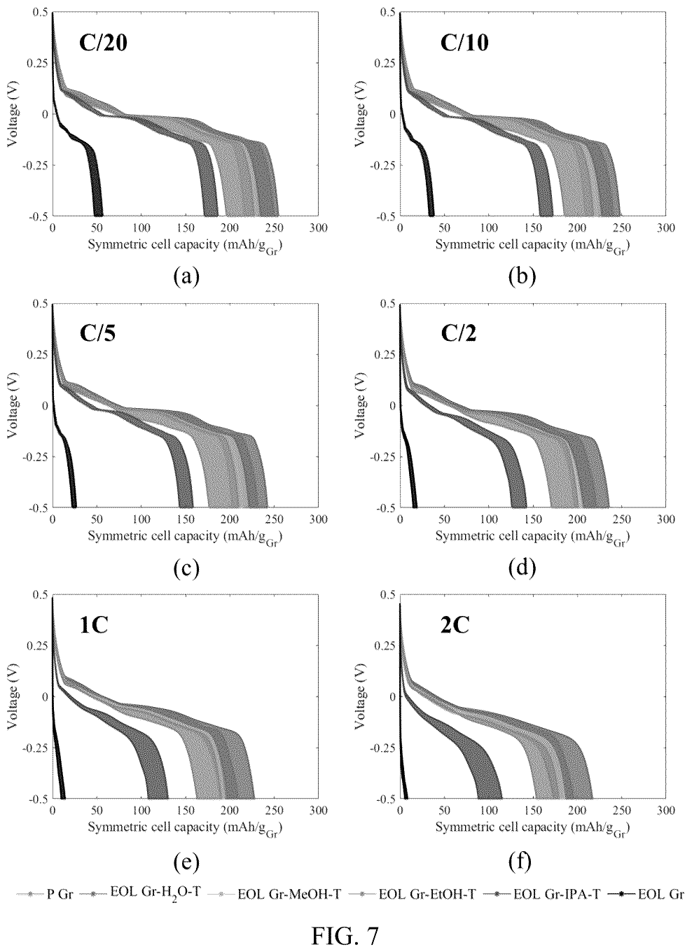

As shown in FIG. 3(d), the voltage gap increases as pristine Gr (P Gr) is approximately equivalent to EOL Gr treated with water (EOL Gr-H₂O-TO which is less than EOL Gr treated with methanol (EOL Gr-MeOH-T) which is approximately equivalent to EOL Gr treated with ethanol (EOL Gr-EtOH-T) which is less than EOL Gr treated with IPA (EOL Gr-IPA-T) which is less than EOL Gr. Electrodes treated with H₂O, MeOH, and EtOH solvents show voltage-gap values closely similar to the pristine material. Treatment with IPA results in elevated voltage gap values relative to P Gr, although still substantially reduced relative to EOL Gr. The discrepancy in voltage gap between solvent-treated and pristine material increases at higher rates, suggesting that the upcycled material is more kinetically limited. At higher rates, the SEI and charge transfer resistance contributions to overpotential become dominant and the performance gap associated with a “poor” (resistive, defective) versus a “good” (less-resistive, less-defective) anode surface is more highly evident. The observed non-linearity in voltage gap vs rate results from the transition from linear to Tafel regime for Li intercalation and SEI kinetics at high current rates. FIG. 7 shows the corresponding symmetric cell voltage versus discharge capacity performance at each current rate for the different solvent treatments. At slow current rates of C/20/C/10, the thermodynamic staging behavior is visible for all graphite samples albeit with substantially decreased plateau lengths for the worst performing EOL Gr-IPA-T and EOL Gr samples. The increased overpotentials at high current rates lead to a complete loss of thermodynamic staging behavior for these samples. P Gr and EOL Gr-H₂O-T retain high performance (greater than approximately 200 mAh/gGr) at a high current rate of 2C.

The development of non-mass-normalized metrics, as discussed in relation to half-cell capacity measurements, is paramount to understanding and appropriately evaluating the quality of upcycled graphite material and to effectively assessing performance across solvent washings. The above-described voltage gap technique is a promising metric in that respect. Furthermore, the C/10 symmetric cell break-in cycles can be analyzed to evaluate irreversible capacity losses. This approach capitalizes on the unique configuration of the symmetric cell, which contains a fixed Li inventory; thus, any Li lost during formation may reasonably be attributed to SEI growth on the graphite electrodes. An ideal solvent wash treatment would leave behind well-passivating SEI species, reducing subsequent SEI growth and associated Li loss. In the present analysis, capacity loss has been normalized to the first-cycle discharge capacity of each symmetric cell, which allows for a truly mass-independent metric. Capacity loss to the SEI can be computed in two different ways, which are reported in FIG. 4(a) and FIG. 4(b). FIG. 4(a) shows the cumulative irreversible capacity loss to the SEI from the second C/10 cycle to the tenth C/10 cycle, normalized to the first-cycle discharge capacity. The first C/10 charge cycle of the symmetric cell occurs between the initial voltage on assembly (approximately −2.5 V) and approximately 0.5 V, and the subsequent discharge cycle occurs from approximately 0.5 V to approximately −0.5 V. Since the voltage limits during charge and discharge for the first C/10 cycle are different than for subsequent cycles, the first cycle was excluded from the irreversible capacity loss metric as the capacity difference between charge and discharge is in part attributable to reversible Li exchange in the symmetric cell voltage range of approximately −2.5 V to approximately −0.5 V. FIG. 4(a) implies that MeOH washing of EOL anodes decreases Li losses during formation relative to pristine Gr. Solvent-treatment efficacy, as measured by formation capacity losses, increases as MeOH<EtOH<water<IPA, with all solvent-treated EOL samples showing reduced Li loss relative to the cycled material. This latter result is somewhat surprising, as it would be presumed that a heavily cycled Gr material would contain a stabilized SEI that would not experience additional Li loss during continued cycling. One potential explanation for this could be that the established SEI on the EOL Gr was disrupted and rendered non-passivating by oxygen or moisture exposure during the cell disassembly, handling, transport, storage, or cell-reassembly.

FIG. 4(b) shows the normalized capacity loss calculated in a different manner: specifically, simply subtracting the discharge capacity obtained in the final C/10 symmetric cell break-in cycle from the nominal discharge capacity in the first break-in cycle. Despite the difference in calculation methodology, the same trends in capacity loss are observed as in FIG. 4(a), namely, that treating EOL Gr with MeOH, EtOH, and H₂O solvents leads to formation capacity losses equivalent to or lesser than (within sample variability) that of pristine Gr, while IPA washing leads to formation capacity losses higher than that of the other treatment solvents, but still lesser than that of the unwashed EOL Gr.

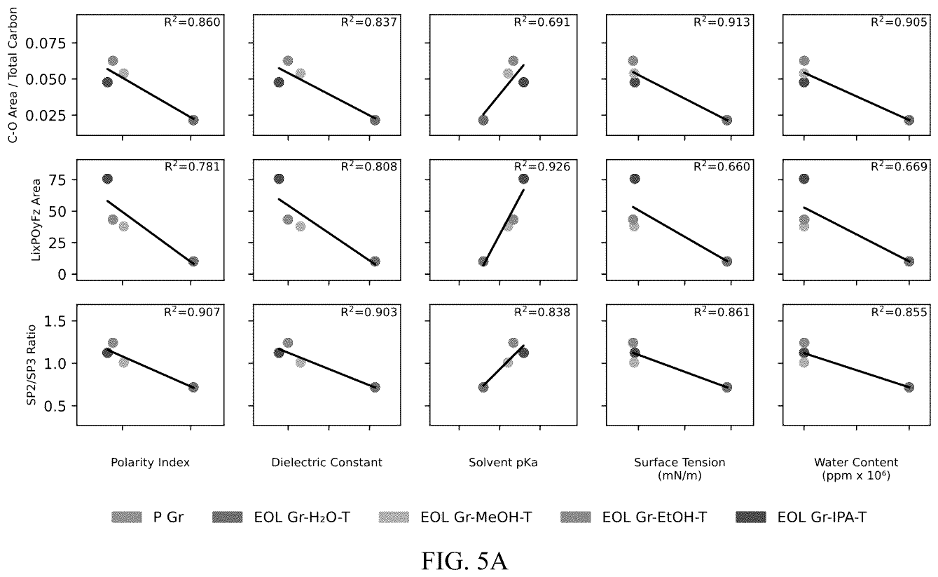

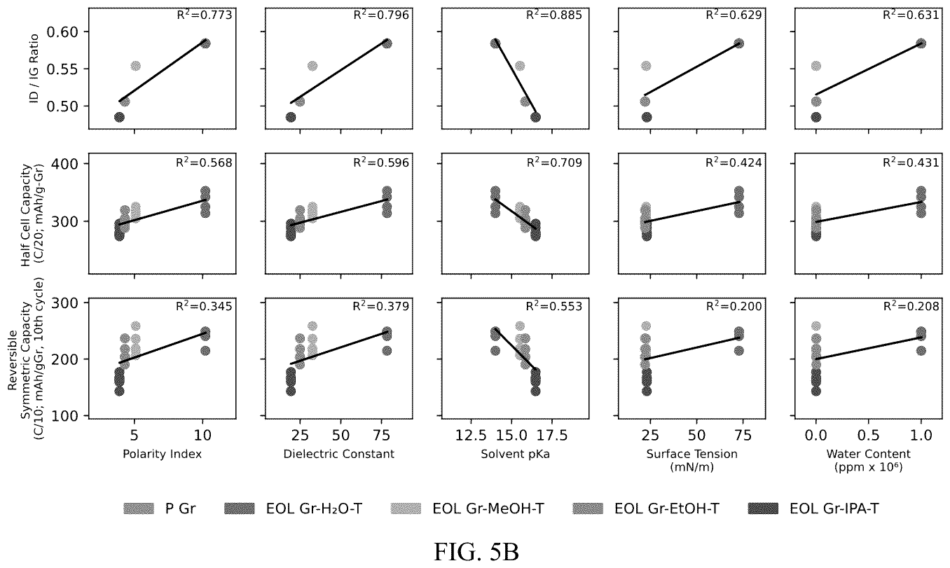

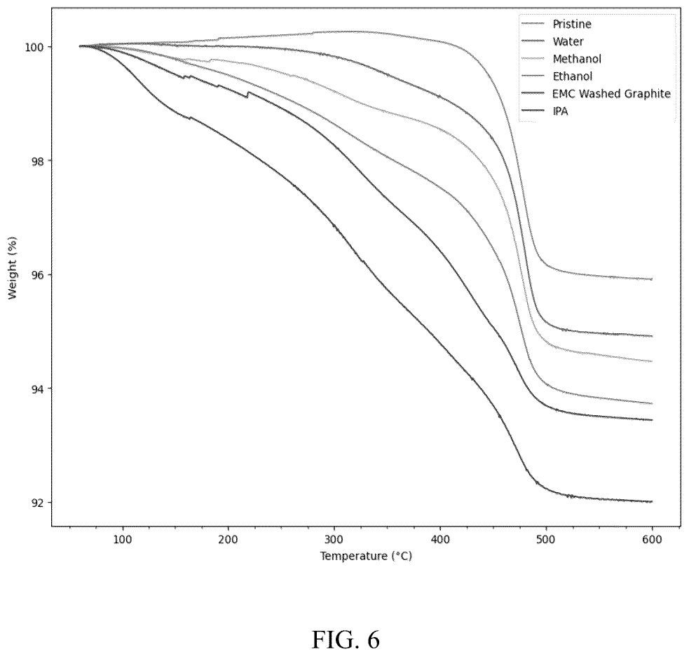

The most highly correlative pairings are shown in FIGS. 5A-B, where higher correlations (i.e., higher R²) indicate parameters that strongly track together. These results provide both a useful summary of the behavior discussed in the above sections and aid in streamlining the analysis of solvent-property/anode-property/performance relationships associated with the present upcycling technique.

First, a more defective graphite structure may evolve during treatment with lower-pKₐ and higher-polarity solvents. Graphite defects have been quantified on the basis of both Raman (I_{D}/I_{G} ratio) and XPS (sp²/sp³ ratio) data with consistent findings. Of the solvent properties evaluated, pKₐ correlates most strongly (R=0.885) with the measured I_{D}/I_{G} ratio, whereas both solvent polarity (R²=0.907 vs polarity index and R²=0.903 vs ε) and pKₐ (R²=0.838 vs pKₐ) correlate strongly with the measured sp²/sp³ ratio. As has been discussed, graphite defects may be introduced from a combination of LiOH evolution with associated surface etching and more vigorous generation of gaseous CO₂ and H₂, which in conjunction with ultrasonication conditions may provide sufficient local energy to induce defects in the graphite structure. Higher I_{D}/I_{G} results in improved rate performance (see FIG. 7), which is expected due to the increased number of defect sites for Li intercalation and diffusion. Higher I_{D}/I_{G} also correlates with higher reversible capacity in both half and symmetric cell configurations, although with weaker correlative strength. This result may be an artifact of the symmetric cell preparation method, whereby the lithiated electrode underwent a full charge/discharge cycle prior to full lithiation resulting in partial masking of irreversible Li losses at defect sites.

Next, the quantity of residual LiₓPO_{y}F_{z} on the anode surface is strongly correlated with solvent pKₐ (R²=0.926). It is perhaps unexpected that LiₓPO_{y}F_{z} content correlates more strongly with pKₐ than with either solvent polarity metrics (polarity index, ε) or solvent water content, since the ionic nature of LiₓPO_{y}F_{z} would imply a greater tendency to solvate in more highly polar matrices. The results in FIGS. 5A-B emphasize the complex interplay of reactivity and solvation in the present set of polar protic solvents. The increased quantity of LiₓPO_{y}F_{z} on the anode surface is likely responsible for the observed increase in cell resistance (see FIG. 3(b)).

Further, the proportion of total C signal on the anode associated with a C—O environment is found to correlate strongly with solvent surface tension (R²=0.913) and solvent water content (R²=0.905), and moderately with solvent polarity metrics (polarity index, ε). C—O environments may originate from oxidized regions on the graphite surface or the presence of carbonate degradation products (e.g., lithium methyl carbonate, lithium ethyl carbonate, lithium ethylene decarbonate, etc.). The negative correlations between C—O content/polarity metrics and C—O content/water content) imply that the presence of highly polar solvents and impurities facilitate enhanced solvation and removal of carbonate degradation species. Interestingly, however, this does not significantly correlate with improved capacity in half or full cells.

While not explicitly evident in the correlations shown in FIG. 4, higher-polarity and lower-pKₐ solvents were found to not only remove “more” SEI (see FIG. 2), but also more residual Li from the graphite structure. This suggests that conversely, lower-polarity and higher-pKₐ solvents retain Li within the graphite structure, essentially resulting in a “prelithiated” graphite anode.

In some embodiments, solvents with high dielectric constants, and solvents with lower pKₐ values appeared to result in improved performance when used as solvent treatments for EOL anodes. Thus, as described in some embodiments herein, treatment of EOL anodes with highly polar protic solvents may both improve electrochemical performance and promote physical characteristics of the SEI that are generally reported to be beneficial (i.e., reduction in resistive fluorophosphate species and more facile Li intercalation facilitated by an increased I_{D}/I_{G} ratio). In some embodiments, solvents including of at least one of water, MeOH and EtOH may be utilized for rejuvenating EOL graphite, but other solvents or combination of solvents may be used.

The present disclosure may result in a utilization of the value of graphite active material in anodes. By recognizing the significance of the solid-electrolyte-interface (SEI) formed on the surface of the graphite during battery operation, the tailored solvent wash approach described herein may selectively remove SEI components. Specifically, water, methanol, ethanol, and isopropanol may be safe and cost-effective solvents to remove specific SEI components such as lithium fluorophosphates and carbonate derived organics. Correlations between the solvent properties, composition of the retained SEI, and the electrochemical performance of the recycled electrode were established. While these facile solvent treatments recover the electrochemical performance of the recycled EOL graphite to near that of pristine graphite, they fall short of producing a definitively better performance. However, these results suggest the potential of recycled graphite as a valuable resource in the broader context of sustainable battery technology when recycled using the method 100 described herein. By harnessing the beneficial aspects of SEI, the method 100 of this present disclosure may pave the way for advancing the economic and environmental sustainability of LIB recycling.

In some embodiments, solvent-treated EOL electrodes show reduced Li loss relative to the cycled material. This latter result is somewhat surprising, as it is typically presumed that a heavily cycled Gr material would contain a stabilized SEI that would not experience additional Li loss during continued cycling. This also indicates a reduction in the density of Gr defect sites with treatment, since defects in the Gr structure serve as facile Li intercalation pathways and are therefore more prone to irreversible consumption of Li through SEI growth. It is also plausible that the EOL Gr SEI was disrupted and rendered non-passivating by oxygen or moisture exposure during the cell disassembly, handling, transport, storage, or cell-reassembly.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

1. A method comprising:
placing an anode black mass into a solvent to form a mixture;
agitating the mixture;
separating the mixture into a used solvent and a retained solid; and
drying the retained solid.

2. The method of claim 1, further comprising:
inserting the retained solid into a lithium ion battery (LIB) as an anode.

3. The method of claim 1, wherein:
the solvent comprises a protic solvent.

4. The method of claim 3, wherein:
the protic solvent comprises at least one of water, methanol, ethanol, or isopropanol.

5. The method of claim 1, wherein:
the placing results in the anode black mass being at least partially submerged in the solvent.

6. The method of claim 1, wherein:
the agitating comprises at least one of sonicating or stirring.

7. The method of claim 1, wherein:
the separating comprises:
centrifuging the mixture; and
decanting the used solvent from the mixture.

8. The method of claim 1, wherein:
the retained solid comprises graphite.

9. The method of claim 1, wherein:
the inserting comprises:
grinding the retained solids; and
re-coated onto a foil.

10. The method of claim 9, wherein:
the foil comprises a copper foil.

11. The method of claim 1, wherein:
the anode black mass has a solid-electrolyte interface (SEI) having a first thickness,
the retained solid has a SEI having a second thickness, and
the second thickness is less than the first thickness.

12. The method of claim 2, wherein:
the LIB has a reduced capacity loss compared to an LIB with a pristine anode.

13. The method of claim 1, further comprising:
repeating the agitating, the separating, and the drying; wherein:
the repeating is performed prior to the inserting.

14. The method of claim 13, wherein:
the repeating is performed at least twice.

15. (canceled)

16. A device comprising:
a lithium-ion battery comprising an anode; wherein:
the anode comprises a graphite that had been used as a first anode in a first lithium-ion battery, and
the graphite comprises a solid-electrolyte-interface comprised of an organic species.

17. The device of claim 16, wherein:
the graphite comprises the first anode treated with a solvent.

18. The device of claim 17, wherein:
the solvent comprises a protic solvent.

19. The device of claim 18, wherein:
the protic solvent comprises at least one of water, methanol, ethanol, or isopropanol.

20. The device of claim 17, wherein:
the first anode comprises an organic species and an inorganic species, and
the solvent is configured to remove at least a portion of the inorganic species.
